(19) United States
(12) Patent Application Publication
(10) Pub. No.: US 2025/0154367 A1
(43) Pub. Date: May 15, 2025

(54) OBJECTS CONTAINING CRYSTALLINE BORON NITRIDE AND METHODS OF MANUFACTURING SAME

(71) Applicant: Raptor Sports Pty Ltd, Gilston, Queensland (AU)

(72) Inventor: Craig LEACH, Gilston, Queensland (AU)

(21) Appl. No.: 18/838,364

(22) PCT Filed: Feb. 20, 2023
(86) PCT No.: PCT/AU2023/050111

§ 371 Date: Aug. 14, 2024

(30) Foreign Application Priority Data
Feb. 28, 2022 (AU) 2022900478
Nov. 21, 2022 (AU) 2022275406
Jan. 13, 2023 (AU) 2023900074
Jan. 23, 2023 (AU) 2023900153

(51) Int. Cl. C09D 7/61; A01K 87/00; A63B 37/00; A63B 53/10; B29C 70/08; B29C 70/44; B29K 63/00; B29K 307/04; B29K 309/04; B29K 505/02; B29K 505/08; B29L 11/00; B29L 31/00; B29L 31/52; B29L 31/54; B32B 5/02; B32B 5/26; B32B 17/06; C08K 3/04; C08K 3/38; C08K 7/24; C09D 7/40; C09D 163/00; G04B 39/00

(52) U.S. Cl. CPC C09D 7/61; B29C 70/08; B29C 70/44; B32B 5/02; B32B 5/26; B32B 17/06; C09D 7/70; C09D 163/00; G04B 39/004; A01K 87/00; A63B 37/0003; A63B 53/10; A63B 2209/02; B29K 2063/00; B29K 2307/04; B29K 2309/04; B29K 2505/02; B29K 2505/08; B29L 2011/00; B29L 2031/5227; B29L 2031/546; B29L 2031/7002; B32B 2260/023; B32B 2260/046; B32B 2262/105; B32B 2262/106; B32B 2262/14; B32B 2264/105; B32B 2457/208; C08K 3/041; C08K 2003/385; C08K 7/24; C08K 2201/014; C08K 2201/017

(57) ABSTRACT

A method of manufacturing an object including: impregnating a material comprising a plurality of boron nitride structures, the boron nitride structures comprising boron nitride nanotubes, or a hybrid of two or more forms of crystalline boron nitride structures, with a matrix material to form a composite material; moulding the composite material; and curing the composite material, wherein the object is at least partially fabricated from the composite material.

### TECHNICAL FIELD

The present invention relates to objects containing crystalline boron nitride and a method of manufacturing same. In particular, the present invention relates to objects fabricated from crystalline boron nitride structures and a method of manufacturing same.

### BACKGROUND

Almost all sporting product manufacturers have a shared goal to make equipment lighter, stronger and faster. Advances in material technology such as use of composite materials and fibre reinforced materials have improved modern sporting equipment such as racquets, golf clubs, sticks, bats, and fishing rods. Composite materials have also been used to improve safety in sporting equipment, such as in cockpit construction in racing cars. In particular, modern sporting equipment is often fabricated from graphite, carbon fibre, fibreglass, or a composite mix including boron, graphite, or a ceramic additive.

Inclusion of novel materials, such as graphite, fibreglass, and carbon fibre, in fishing rods have assisted in improving the strength and reducing the weight of the rod while providing sensitivity to feel the biting fish. While fishing rods comprising graphite are lighter, more flexible and have better sensitivity, they are prone to being stiff and/or brittle, causing the rod to snap under load. Golf club shafts suffer from the same issues.

Sporting equipment may also be fabricated from hybrid or multilayer materials, composite materials, and the like. For example, racquets may be fabricated from fibre-reinforced composite materials such as fibreglass, carbon fibre and aramid which have been moulded into shape. While manufacturing racquets from composite materials provides sporting equipment manufacturers with improved freedom of design, mass distribution and stiffness, the higher stiffness of the racquets may increase risk of injury to the player due to repetitive strain-like injuries.

While a number of crystalline forms of boron nitride exist, these are considered to be both difficult and expensive to produce (particularly in comparison to more commonly used materials) and their properties, performance and cost-effectiveness in commercial applications such as sporting equipment (in which a combination of mechanical strength, flexibility and elastic deformability) are untested and unknown.

One specific example of the use of boron nitride nanotubes in body armour, vehicle armour and protective padding for sports is disclosed in US 2017/0190143. In these embodiments, the presence of boron nitride structure is intended to provide impact resistance, and not improved flexibility or elastic deformability. This document discloses items that are designed to maximise energy absorption using high hardness layers, and which would be entirely unsuitable for use in sporting equipment (such as golf clubs, golf balls and fishing rods) which require a high degree of flexibility and elastic deformability in order to function in the desired manner.

Thus, there would be an advantage if it were possible to provide sporting equipment that maintained the relatively light, flexible constructions of existing composite materials, while also improving the strength, flexibility and/or elastic deformability of the sporting equipment and reducing the risk of injury to users.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide objects at least partially fabricated from a composite material, the composite material comprising a plurality of boron nitride structures, the boron nitride structures comprising boron nitride nanotubes, or a hybrid of two or more forms of crystalline boron nitride structures, within a matrix material.

The invention also provides a method of manufacturing objects at least partially fabricated from a material comprising a plurality of boron nitride structures, the boron nitride structures comprising boron nitride nanotubes, or a hybrid of two or more forms of crystalline boron nitride structures, which may at least partially address one or more of the problems or deficiencies mentioned above or which may provide the public with a useful or commercial choice. The objects may include sporting equipment, screens for computing devices, watch components as well as surface coating materials.

The term “surface coating material” as used herein is broadly defined as a material that may be applied to the surface of an object. Exemplary surface coatings may include paint, varnish, adhesive sheets, and nail polish.

The term “sporting equipment” as used herein is broadly defined as an object that may be used during a particular sporting, recreational or fitness activity. Exemplary sporting equipment may include golf clubs, golf balls, sticks (such as, but not limited to, hockey sticks), bats (such as, but not limited to, cricket bats, baseball bats and the like), paddles, racquets, vaulting poles, fishing rods, and the like, or parts thereof.

The term “crystalline boron nitride structures” as used herein is intended to refer to non-amorphous forms of boron nitride. More specifically, the term is intended to refer to crystalline structures that consist of a single layer or multiple layers of boron nitride. The term “crystalline boron nitride structures” as used herein and, unless otherwise qualified, is intended to encompass forms of crystalline boron nitride such as boron nitride nanotubes, boron nitride ribbon, boron nitride wire, boron nitride sheets, boron nitride nanosheets, boron nitride nano wire, boron nitride nano ribbon, or any combination thereof. The crystalline boron nitride structures may comprise a single crystalline form of boron nitride. Alternatively, the crystalline boron nitride structures may comprise two or more forms of crystalline boron nitride.

Preferably, the hybrid of two or more forms of crystalline boron nitride structures may comprise a combination of boron nitride nanotubes, boron nitride wire, boron nitride ribbon and/or boron nitride nanosheets. The various crystalline boron nitride structures may be present in any suitable concentration. For instance, equal amounts (by weight or by volume) of each of the boron nitride structures may be provided. Alternatively, each form of boron nitride structure may comprise between 0.1% and 99.9% (by weight or by volume) of the total quantity of crystalline boron nitride structures.

In some embodiments of the invention, the two or more forms of crystalline boron nitride structures may comprise boron nitride nanotubes and boron nitride wire, or boron nitride nanotubes and boron nitride ribbon, or boron nitride nanotubes and boron nitride nanosheets, or boron nitride wire and boron nitride ribbon, or boron nitride wire and boron nitride nanosheets, or boron nitride ribbon and boron nitride nanosheets. In some embodiments of the invention, the crystalline boron nitride structures may comprise any combination of three of boron nitride nanotubes, boron nitride wire, boron nitride ribbon and/or boron nitride nanosheets. In some embodiments, the crystalline boron nitride structures may comprise all four of boron nitride nanotubes, boron nitride wire, boron nitride ribbon and/or boron nitride nanosheets.

Thus, according to a first aspect of the present invention, the invention resides broadly in an item of sporting equipment at least partially fabricated from a composite material, the composite material comprising a plurality of boron nitride structures, the boron nitride structures comprising boron nitride nanotubes, or a hybrid of two or more forms of crystalline boron nitride structures.

In some embodiments, the item of sporting equipment may be at least partially fabricated from the composite material comprising a plurality of boron nitride structures, the boron nitride structures comprising boron nitride nanotubes, or a hybrid of two or more forms of crystalline boron nitride structures, within a matrix material and at least partially fabricated from other materials. For instance, the frame of a racquet may be fabricated from the composite material while the strings and a grip portion of the handle may be fabricated from other materials. Similarly, a portion of the head of a golf club (such as, but not limited to the club face) may comprise a composite material and remaining portions of the head may be fabricated from other materials. In some embodiments, substantially the entire head of the golf club could be fabricated from the composite material.

In some embodiments, the item of sporting equipment may be at least partially fabricated from two or more different types of composite material comprising a plurality of boron nitride structures, the boron nitride structures comprising boron nitride nanotubes, or a hybrid of two or more forms of crystalline boron nitride structures, within a matrix material. In use, it is envisaged that fabricating the item of sporting equipment from two or more different types of composite material may provide the item of sporting equipment with regions having different properties. For instance, the regions may have different stiffness values, impact resistance, dampening, strength-to-weight ratio, or the like. For instance, the head of the golf club may be fabricated from a first composite material and the shaft of the golf club may be fabricated from a second composite material. The first and second composite materials may differ in any suitable manner. For instance, the first and second composite materials may make use of a different matrix material, or a different concentration of crystalline boron nitride structures within the matrix. In other embodiments, the composite materials may include different additives therein, the additives being configured to provide the composite materials with particular physical properties. For instance, it may be desired that the composite material be elastically deformable.

Any suitable portion of the sporting equipment may be at least partially fabricated from the composite material. Generally, the portion may be a portion of the item of sporting equipment which may benefit from one or more of improved strength, reduced weight, improved flexibility, improved damping, increased durability, and the like. For instance, the portion of the sporting equipment may comprise a contact portion such as a head of a golf club or hockey stick, a frame of a racquet, a bat trunk of a baseball bat, a blade of a cricket bat, or the like. Further, the portion of the sporting equipment may be a grip portion or a portion which enables a user to manipulate the sporting equipment such as a shaft, bat, handle, rod, a vaulting pole, or the like of the sporting equipment. Still further, the portion of the sporting equipment may be a portion which in use may be under high load such as the shaft of a fishing rod, the shaft of a golf club, or the shaft of a vaulting pole.

In some embodiments, substantially all of the item of sporting equipment may be fabricated from the composite material.

The composite material may be of any suitable type. Generally, however, the composite material may be suitable for shaping. Any suitable shaping process may be used, such as, but no limited to, casting, moulding, extrusion, sheet or filament forming, machining, printing, laser cutting or the like, or any suitable combination thereof. For instance, the composite material may comprise a composite material (or a nanocomposite material) comprising a plurality of boron nitride structures, the boron nitride structures comprising boron nitride nanotubes, or a hybrid of two or more forms of crystalline boron nitride structures, dispersed within a polymer, metal and/or ceramic matrix, an assembly of a plurality of boron nitride structures, the boron nitride structures comprising boron nitride nanotubes, or a hybrid of two or more forms of crystalline boron nitride structures, impregnated with a polymer, metal and/or ceramic material, a material at least partially coated with a plurality of boron nitride structures, the boron nitride structures comprising boron nitride nanotubes, or a hybrid of two or more forms of crystalline boron nitride structures, such that a multi-layered structure is formed, or the like.

It will be understood that the shaping process that is used to form the item of sporting equipment from the composite material will depend on the nature of the item of sporting equipment. For instance, in embodiments of the invention in which the item of sporting equipment comprises an elongate member (such as a fishing rod, golf club shaft or the like), the composite material may be moulded about a mandrel to form the item of sporting equipment. In other embodiments, such as when the item of sporting equipment comprises the club face of a golf club, the composite material may be cast to form the item of sporting equipment.

As previously indicated, the composite material comprises a plurality of boron nitride structures, the boron nitride structures comprising boron nitride nanotubes, or a hybrid of two or more forms of crystalline boron nitride structures, within a matrix material. In some embodiments, a material comprising a plurality of boron nitride structures, the boron nitride structures comprising boron nitride nanotubes, or a hybrid of two or more forms of crystalline boron nitride structures, may be impregnated with a matrix material to form a composite material. It will be understood that the material comprising a plurality of boron nitride structures, the boron nitride structures comprising boron nitride nanotubes, or a hybrid of two or more forms of crystalline boron nitride structures, may comprise a material of which the plurality of boron nitride structures form a portion. For instance, the plurality of boron nitride structures, the boron nitride structures comprising boron nitride nanotubes, or a hybrid of two or more forms of crystalline boron nitride structures, may be contained within a material. This material may be retained within the matrix or may be removed or destroyed when the matrix material is added thereto. Alternatively, the material may comprise a plurality of boron nitride structures, the boron nitride structures comprising boron nitride nanotubes, or a hybrid of two or more forms of crystalline boron nitride structures, as well as other components, such as, but not limited to, a plurality of carbon nanotubes.

In other embodiments, the term “a plurality of boron nitride structures, the boron nitride structures comprising boron nitride nanotubes, or a hybrid of two or more forms of crystalline boron nitride structures” may simply refer to a plurality of boron nitride structures.

Any suitable matrix material may be used. For instance, the matrix material may be a polymer, a metal and/or a ceramic matrix material. Preferably, the matrix material may comprise a polymer.

In some embodiments, the polymer may at least partially coat the material, may substantially encase the material, may impregnate the material such that the polymer at least partially fills any openings in and or around the plurality of boron nitride structures, or any suitable combination thereof. Generally, however, the polymer may bond to the material such that the material and the polymer may not separate from one another.

In a preferred embodiment of the invention, the polymer material may be provided in liquid form, and may be allowed to flow around and/or into the material to at least partially penetrate and/or encapsulate the plurality of boron nitride structures. Preferably, the polymer may be allowed to at least partially set to form a solid composite material.

Any suitable polymer may be used. For instance, the polymer may be polyethylene, polypropylene, polystyrene, polyvinyl chloride, polyether sulphones, acrylonitrile butadiene styrene, polyether polyols, polyester polyols, polyacetal or polyoxymethylene (acetal, POM), polycarbonates, elastomers, thermoplastic elastomers, thermoplastic polyester, thermoplastic polyurethane, polyketones (such as but not limited to polyaryletherketone (PAEK), polyetheretherketone (PEEK), polyetherketoneketone (PEKK) or the like), acrylate polymers, poly(methyl methacrylate) (PMMA), polyphenylene sulfide (PPS), polyamides, polyphthalamide (PPA, performance Nylon), fluoropolymers (such as, but not limited to, polytetrafluoroethylene (PTFE), fluorinated ethylene propylene (FEP), polyvinylidene fluoride or polyvinylidene difluoride (PVDF), polychlorotrifluoroethylene (PCTFE), perfluoroalkoxy alkane (PFA), or the like), high density polyethylene (HDPE), ultra-high molecular weight polyethylene (UHMWPE), epoxy resins, phenolic resins, and the like, their monomers thereof, or any suitable combination thereof. In a preferred embodiment of the invention, the polymer may be a thermosetting polymer.

In some embodiments, the polymer may be an epoxy resin. Any suitable type of epoxy resin may be used, such as a bisphenol epoxy resins, an aliphatic epoxy resins, a novolac epoxy resin, a halogenated epoxy resin, an epoxy resin diluent, and/or a glycidylamine epoxy resin.

In some embodiments, the matrix material may comprise two or more polymers. The two or more polymers may be the same type of polymer or may be of different types.

The matrix material may comprise any suitable portion of the composite material. For instance, in some embodiments of the invention, the matrix material may comprise between about 25 wt % and 99.95 wt % of the composite material. More preferably, the matrix material may comprise between about 45 wt % and 99.9 wt % of the composite material. Most preferably, the matrix material may comprise between about 90 wt % and about 99.5 wt % of the composite material.

The composite material may comprise any suitable weight percent of boron nitride structure, in the matrix material. For instance, the composite material may comprise between about 0.05 wt % and about 75 wt % boron nitride structures. More preferably, the composite material may comprise between about 0.1 wt % and about 55 wt % boron nitride structures. Still more preferably, the composite material may comprise between about 0.5 wt % and about 50 wt % boron nitride structures. Yet more preferably, the composite material may comprise between about 0.5 wt % and about 30 wt % boron nitride structures. Even more preferably, the composite material may comprise between about 0.5 wt % and about 20 wt % boron nitride structures. Still more preferably the composite material may comprise between about 0.5 wt % and about 10 wt % boron nitride structures.

In some embodiments, the composite material may further comprise a metal. Any suitable metal may be used, such as titanium or alloys thereof, zirconium or alloys thereof, aluminium or alloys thereof, copper or alloys thereof, or the like. In some embodiments, the composite material may comprise a metal-boron nitride structure layered structure wherein a metal material may be at least partially coated with boron nitride structures, a plurality of metal particles dispersed within a material comprising a plurality of boron nitride structures, a plurality of boron nitride structures dispersed within a metal-based structure, or the like.

In some embodiments, the composite material may further comprise a fibre such as aramid fibre, carbon fibre, carbon nanotubes, a glass fibre, a polymer fibre, or the like.

In embodiments of the invention in which the composite material further comprises carbon nanotubes, the carbon nanotubes may be present in any suitable concentration. For instance, the composite material may comprise between about 0.05 wt % and about 80 wt % carbon nanotubes. More preferably, the composite material may comprise between about 0.1 wt % and about 65 wt % carbon nitride nanotubes. Still more preferably, the composite material may comprise between about 0.5 wt % and about 50 wt % carbon nanotubes. Yet more preferably, the composite material may comprise between about 0.5 wt % and about 30 wt % carbon nanotubes. Even more preferably, the composite material may comprise between about 0.5 wt % and about 20 wt % carbon nanotubes. Still more preferably the composite material may comprise between about 0.5 wt % and about 10 wt % carbon nanotubes.

The composite material may be provided in any suitable form. In a preferred embodiment of the invention, however, the composite material may be provided in the form of a tape, sheet, film or the like.

The applicant has discovered that boron nitride structures may have a tendency to agglomerate or clump in certain circumstances and at certain concentrations within the composite material. This agglomeration of boron nitride structures may result in a non-homogenous distribution of boron nitride structures within the composite material, which in turn reduces the advantageous mechanical and physical properties of the composite material.

Thus, in some embodiments of the invention, the composite material may further comprise a dispersant. Any suitable dispersant may be used, although it will be understood that the purpose of the dispersant may be to ensure that the boron nitride structures are substantially homogenously distributed within the composite material.

The dispersant may be of any suitable form. For instance, the dispersant may comprise an inorganic solvent, such as, but not limited to, N, N-dimethylformamide, N-methyl-2-pyrrolidone, hexamethylphosphoramide, N-methylcaprolactam, dimethyl sulfoxide, N-acetyl-2-pyrrolidone, N, N-dimethyl. Acetamide, water, monohydric alcohols such as methanol, ethanol, propanol, isopropanol and butanol, dihydric alcohols such as ethylene glycol and propylene glycol, trihydric alcohols such as glycerin, ketones such as acetone, cyclic ethers such as tetrahydrofuran, halogenated aromatic hydrocarbons such as 1,2-dichlorobenzene, haloalkanes such as chloroform, 1-methylnaphthalene, and so on. In some embodiments of the invention, the dispersant may comprise sodium dodecylbenzene sulfonate.

In some embodiments of the invention, the dispersant may comprise a surfactant. The surfactant may be of any suitable form, although in a preferred embodiment of the invention the surfactant may comprise a non-ionic surfactant, and particularly a hydrophilic non-ionic surfactant. In some embodiments of the invention, the dispersant may comprise a poloxamer. In some embodiments, the dispersant may comprise a triblock copolymer.

In some embodiments, a grip portion or a portion which enables a user to manipulate the sporting equipment may be at least partially fabricated from a material comprising a plurality of boron nitride nanotubes, or a hybrid of two or more forms of crystalline boron nitride structures, within a matrix material. For instance, the grip portion may be a shaft, bat, handle, rod, vaulting pole, or the like.

In other embodiments, a contact portion of the sporting equipment may be at least partially fabricated from a composite material comprising a plurality of boron nitride nanotubes, or a hybrid of two or more forms of crystalline boron nitride structures, within a matrix material. The term “contact portion” as used herein is intended to refer to the portion of the sporting equipment configured to contact or impact an object when participating in a sport. For instance, the contact portion may be a club face of a golf club or hockey stick, a frame of a racquet, a bat trunk of a baseball bat, a blade of a cricket bat, or the like.

In preferred embodiments, the item of sporting equipment may be a golf club, golf ball or a fishing rod.

In embodiments of the invention in which the sporting equipment comprises a golf ball, it is envisaged that one or more layers of the golf ball may be fabricated from the composite material. The one or more layers may include the core, the cover and/or one or more layers of the golf ball located between the core and the cover.

According to a second aspect of the present invention, there is provided a method of manufacturing an item of sporting equipment, the method including: impregnating a material comprising a plurality of boron nitride structures, the boron nitride structures comprising boron nitride nanotubes, or a hybrid of two or more forms of crystalline boron nitride structures, with a matrix material to form a composite material; moulding the composite material; and curing the composite material to form the item of sporting equipment, wherein the item of sporting equipment is at least partially fabricated from the composite material.

Preferably, the matrix material of the first aspect is the matrix material of the second aspect.

The material comprising a plurality of a plurality of boron nitride structures, the boron nitride structures comprising boron nitride nanotubes, or a hybrid of two or more forms of crystalline boron nitride structures, may be of any suitable form. For instance, the material may comprise an assembly of boron nitride structures such as fibrils, tubes, yarns, films, tapes, sheets, wires, ribbons, buckypaper, or the like. For instance, the material may comprise an injectable composition. However, it will be appreciated by a person skilled in the art that the form of the material may vary depending on a number of factors such as the moulding manufacturing process and the application of the sporting equipment.

In some embodiments, the material may be relatively dry. In this instance, it will be understood that the material may comprise a plurality of boron nitride structures that are substantially free of a polymer before being impregnated with a matrix material.

Preferably, the matrix material may comprise a polymer. Any suitable polymer may be used. For instance, the polymer may be polyethylene, polypropylene, polystyrene, polyvinyl chloride, polyether sulphones, acrylonitrile butadiene styrene, polyether polyols, polyester polyols, polyacetal or polyoxymethylene (acetal, POM), polycarbonates, elastomers, thermoplastic elastomers, thermoplastic polyester, thermoplastic polyurethane, polyketones (such as but not limited to polyaryletherketone (PAEK), polyetheretherketone (PEEK), polyetherketoneketone (PEKK) or the like), acrylate polymers, poly(methyl methacrylate) (PMMA), polyphenylene sulfide (PPS), polyamides, polyphthalamide (PPA, performance Nylon), fluoropolymers (such as, but not limited to, polytetrafluoroethylene (PTFE), fluorinated ethylene propylene (FEP), polyvinylidene fluoride or polyvinylidene difluoride (PVDF), polychlorotrifluoroethylene (PCTFE), perfluoroalkoxy alkane (PFA), or the like), high density polyethylene (HDPE), ultra-high molecular weight polyethylene (UHMWPE), epoxy resins, phenolic resins, and the like, their monomers thereof, or any suitable combination thereof.

In some embodiments the polymer may comprise a thermosetting polymer, and, specifically, a thermosetting resin. Any suitable thermosetting resin may be used, such as, but not limited to, polyester resin, polyurethane, polyurea/polyurethane hybrids, vulcanized rubber, bakelite, duroplast, Urea-formaldehyde foam, melamine resin, diallyl-phthalate (DAP), epoxy resin, epoxy novolac resins, benzoxazines, polyimides, bismaleimides, cyanate esters, polycyanurates, furan resins, silicone resins, thiolyte or vinyl ester resins.

In other embodiments, the material may be pre-impregnated with an amount of a polymer. In this instance, the polymer used to provide a pre-composite material may be the same type of polymer or a different type of polymer used to impregnate the material.

In some embodiments, the polymer may be an epoxy resin. Any suitable type of epoxy resin may be used, such as a bisphenol epoxy resins, an aliphatic epoxy resins, a novolac epoxy resin, a halogenated epoxy resin, an epoxy resin diluent, and/or a glycidylamine epoxy resin.

In some embodiments, the polymer may comprise a hardener. In this instance, it is envisaged that the hardener may assist in the curing of the composite material. The hardener may be of any suitable form, such as, but not limited to one or more aliphatic and aromatic amines, anhydrides or polyamides, or any suitable combination thereof. In embodiments of the invention in which the hardener comprises an anhydride, the anhydride may comprise phthalic anhydride, tetrahydrophthalic anhydride, hexahydrophthalic anhydride, pyromellitic dianhydride, 3, 3, 4, 4-tetracarboxybenzophenonedianhydride, chlorendic anhydride, methylnadic anhydride and/or trimellitic anhydride.

The material comprising a plurality of boron nitride structures, the boron nitride structures comprising boron nitride nanotubes, or a hybrid of two or more forms of crystalline boron nitride structures, may be impregnated with a polymer using any suitable technique known in the art. For instance, the material may be impregnated by applying a polymer to the surface of the material until the required thickness is achieved (such as by coating, by deposition, by spraying, etc.), the polymer may be absorbed into the material, the polymer may be injected into a mould cavity comprising the material during an injection moulding process, the polymer may be pressed into the material during a vacuum moulding process, or the like. In some embodiments of the invention, the polymer may be provided in liquid form and allowed to at least partially set after being introduced to the plurality of boron nitride structures in order to form the composite material.

As previously stated, the composite material may be shaped using any suitable process known in the art, and the shaping process used may be determined by the nature of the item of sporting equipment to be formed. In some embodiments of the invention, the composite material may be moulded to form the item of sporting equipment. In this embodiment, the composite material may be moulded using spray-forming, filament winding, liquid forming, resin transfer moulding, compression moulding, injection moulding, vacuum autoclave, vacuum induction, induction heating, high temperature moulding, lamination moulding, pultrusion moulding, bladder moulding, mandrel moulding or the like.

The composite material may be cured using any suitable process known in the art. In this instance, it will be understood that curing is a chemical process which initiates cross-linking of polymer chains causing the polymer to harden or toughen. However, a person skilled in the art will appreciate that the curing process may vary depending on a number of factors such as the type of polymer, the form of the material, the desired properties of the composite material and the moulding manufacturing process. For instance, the composite material may be cured using an additive, radiation, temperature and/or pressure.

In some embodiments, the composite material may comprise one or more layers of material. In embodiments of the invention in which the composite material comprises two or more layers of material, the two or more layers of material may be laminated together to form a laminated composite material (for instance, about a mandrel, by applying pressure and/or an adhesive etc.) and cured using a hardener and/or by applying pressure and/or temperature to form the sporting equipment. In embodiments of the invention in which the composite material comprises two or more layers, at least one layer of the laminated composite material may comprise a material other than the composite material. Any other suitable material may be used, and it is envisaged that the other material may be used to impart the laminated composite material with particular properties (such as mechanical properties, electrical properties or the like, or any suitable combination thereof).

According to a third aspect of the present invention, there is provided an item of sporting equipment or a portion thereof when manufactured according to the method of the second aspect.

Advantageously, the item of sporting equipment of the present invention provides improved strength to weight compared to sporting equipment using existing reinforced fibre compositions. Further, the sporting equipment of the present invention has a reduced failure rate due to the improved binding of the boron nitride structures and polymers in the composite material.

It is envisaged that, advantageously, sporting equipment manufactured from the composite material may have improved flexibility and elastic deformability over existing reinforced fibre compositions. This improved flexibility and elastic deformability may reduce damage to, or breakage of, the sporting equipment in high load situations. The composite material may be opaque or at least semi-transparent. Preferably, the composite material provides the item of sporting equipment with a relatively high strength to weight ratio, and relatively high durability.

It is anticipated that a composite material comprising a plurality of boron nitride structures, the boron nitride structures comprising boron nitride nanotubes, or a hybrid of two or more forms of crystalline boron nitride structures, would offer improved strength to weight ratio without compromising. In addition, it is anticipated that a composite material comprising a plurality of boron nitride structures, the boron nitride structures comprising boron nitride nanotubes, or a hybrid of two or more forms of crystalline boron nitride structures, would offer improved thermal stability.

In another aspect, the invention resides broadly in a screen for a computing device, the screen comprising at least one layer, wherein the at least one layer includes a material comprising a plurality of boron nitride structures, the boron nitride structures comprising boron nitride nanotubes, or a hybrid of two or more forms of crystalline boron nitride structures.

The screen may comprise any suitable number of layers. However, in a preferred embodiment of the invention, the screen may comprise a plurality of layers. In a specific embodiment, the screen may comprise at least three layers. In this embodiment, the three layers may comprise a transparent layer, such as a layer fabricated from glass, polymer (such as, but not limited to, a polycarbonate) or the like (wherein the transparent layer is preferably coated with a metallic-conductive coating on an upper surface thereof), a spacer layer and an outer coated layer, and specifically an outer polyester-coated layer (preferably with a metallic-conductive coating on a lower surface thereof). In this embodiment of the invention the polyester-coated layer may include the material comprising a plurality of boron nitride structures, the boron nitride structures comprising boron nitride nanotubes, or a hybrid of two or more forms of crystalline boron nitride structures. Preferably, the polyester-coated layer comprises an outer layer of the screen, while the transparent layer comprises an inner layer of the screen. The outer coated layer may be fabricated from any suitable material, such as glass, polymer (such as, but not limited to, polycarbonate) and the like. The boron nitride structures may be embedded or impregnated within the outer coated layer. Alternatively, the outer coated layer may comprise a mixture of glass or polymer and the composite material according to the other aspects of the invention.

In an alternative embodiment of the invention, the screen may comprise at least four layers. In this embodiment, the five layers may comprise a transparent layer, such as a layer fabricated from glass, polymer (such as, but not limited to, a polycarbonate) or the like (wherein the transparent layer is preferably coated with a metallic-conductive coating on an upper surface thereof), a spacer layer, a coated layer, and specifically a polyester-coated layer (preferably with a metallic-conductive coating on a lower surface thereof), and a layer of material comprising a plurality of boron nitride structures, the boron nitride structures comprising boron nitride nanotubes, or a hybrid of two or more forms of crystalline boron nitride structures. In this embodiment of the invention, the layer of material comprising a plurality of boron nitride structures, the boron nitride structures comprising boron nitride nanotubes, or a hybrid of two or more forms of crystalline boron nitride structures, may comprise an outer layer of the screen. The coated layer may be fabricated from any suitable material, such as glass, polymer (such as, but not limited to, polycarbonate) and the like.

The layer of material comprising a plurality of boron nitride structures, the boron nitride structures comprising boron nitride nanotubes, or a hybrid of two or more forms of crystalline boron nitride structures, may comprise the composite material according to the other aspects of the invention.

It will be understood that the term “inner layer” is intended to refer to the layer of the screen that is located adjacent to the display (such as an LCD display) of the computing device, while the term “outer layer” refers to the layer of the screen that forms at least part of the external surface of the computing device.

Preferably, the spacer layer includes a plurality of sensors configured to sense touching of the screen (whether by a user's finger, or an object such as a stylus).

In other embodiments of the invention, it is envisaged that two or more layers within the screen may include, or be fabricated from, the material comprising a plurality of boron nitride structures, the boron nitride structures comprising boron nitride nanotubes, or a hybrid of two or more forms of crystalline boron nitride structures.

Preferably, the material comprising a plurality of boron nitride structures, the boron nitride structures comprising boron nitride nanotubes, or a hybrid of two or more forms of crystalline boron nitride structures, is the same material as described in respect to the other aspects of the invention.

In a preferred embodiment of the invention, the screen may comprise a touchscreen. The touchscreen may comprise a capacitive touchscreen, a resistive touchscreen, or any other suitable type of touchscreen.

In a preferred embodiment of the invention, the computing device may comprise a mobile telephone, computing tablet, laptop computer, smart watch or the like, or any suitable combination thereof. It is envisaged that, by introducing a material comprising a plurality of boron nitride structures, the boron nitride structures comprising boron nitride nanotubes, or a hybrid of two or more forms of crystalline boron nitride structures, into the screen, the strength and durability (and the resistance to cracking or shattering) of the screen may be improved.

The layers including a plurality of boron nitride structures, the boron nitride structures comprising boron nitride nanotubes, or a hybrid of two or more forms of crystalline boron nitride structures, may comprise any suitable weight percent boron nitride structures in the matrix material. For instance, the layers may comprise between about 0.05 wt % and about 60 wt % boron nitride structures. More preferably, the layers may comprise between about 0.1 wt % and about 55 wt % boron nitride structures. Still more preferably, the layers may comprise between about 0.5 wt % and about 50 wt % boron nitride structures. Yet more preferably, the layers may comprise between about 0.5 wt % and about 30 wt % boron nitride structures. Even more preferably, the layers may comprise between about 0.5 wt % and about 20 wt % boron nitride structures. Still more preferably the layers may comprise between about 0.5 wt % and about 10 wt % boron nitride structures.

It has surprisingly been found that the addition of a plurality of boron nitride structures, the boron nitride structures comprising boron nitride nanotubes, or a hybrid of two or more forms of crystalline boron nitride structures, to the screen not only improves the properties of the screen (such as the mechanical strength, durability, elastic deformability, crack resistance and so on) but also does not have a detrimental effect on the responsiveness of the screen to a user's touch.

In another aspect of the invention, the present invention resides broadly in a component for a watch, the component including a material comprising a plurality of boron nitride structures, the boron nitride structures comprising boron nitride nanotubes, or a hybrid of two or more forms of crystalline boron nitride structures.

The component may be of any suitable type. For instance, the component may comprise a watch crystal, a watch band, a watch casing or the like.

In embodiments of the invention in which the component comprises a watch crystal, the watch crystal may be fabricated from a transparent glass or polymer material that is impregnated with the material comprising a plurality of boron nitride structures, the boron nitride structures comprising boron nitride nanotubes, or a hybrid of two or more forms of crystalline boron nitride structures. Alternatively, the watch crystal may be of conventional design and may be provided with one or more layers of the material comprising a plurality of boron nitride structures, the boron nitride structures comprising boron nitride nanotubes, or a hybrid of two or more forms of crystalline boron nitride structures. The one or more layers of the material comprising a plurality of boron nitride structures, the boron nitride structures comprising boron nitride nanotubes, or a hybrid of two or more forms of crystalline boron nitride structures, may be provided on an inner surface of the watch crystal, an outer surface of the watch crystal, or a combination of the two.

In some embodiments, the watch crystal may be of conventional composition with the addition of a plurality of boron nitride structures, the boron nitride structures comprising boron nitride nanotubes, or a hybrid of two or more forms of crystalline boron nitride structures, embedded or impregnated therewithin. Preferably, the material comprising a plurality of boron nitride structures, the boron nitride structures comprising boron nitride nanotubes, or a hybrid of two or more forms of crystalline boron nitride structures, is the composite material as described in respect to the other aspects of the invention.

The watch crystal and/or the composite material may comprise any suitable weight percent boron nitride structures in the matrix material. For instance, the watch crystal and/or the composite material may comprise between about 0.05 wt % and about 60 wt % boron nitride structures. More preferably, the watch crystal and/or the composite material may comprise between about 0.1 wt % and about 55 wt % boron nitride structures. Still more preferably, the watch crystal and/or the composite material may comprise between about 0.5 wt % and about 50 wt % boron nitride structures. Yet more preferably, the watch crystal and/or the composite material may comprise between about 0.5 wt % and about 30 wt % boron nitride structures. Even more preferably, the watch crystal and/or the composite material may comprise between about 0.5 wt % and about 20 wt % boron nitride structures. Still more preferably the watch crystal and/or the composite material may comprise between about 0.5 wt % and about 10 wt % boron nitride structures.

It is envisaged that a watch fabricated from the component (or a plurality of components) of the present invention may be relatively lightweight, durable and have relatively high impact resistance. Thus, it is envisaged that a watch fabricated from the component (or a plurality of components) of the present invention may be a sports watch.

According to a further aspect of the present invention, the invention resides broadly in a component for a land vehicle at least partially fabricated from a composite material, the composite material comprising a plurality of boron nitride structures, the boron nitride structures comprising boron nitride nanotubes, or a hybrid of two or more forms of crystalline boron nitride structures, within a matrix material.

The land vehicle may be of any suitable form. For instance, the land vehicle may comprise a bicycle. In this embodiment of the invention, the component may comprise a bicycle frame (or portion thereof), handle bars, wheels, tyres or the like.

Preferably, however, the land vehicle is a motor vehicle. In preferred embodiments, the land vehicle may be a car, truck, bus, motorcycle or the like. In these embodiments, the component may be of any suitable type. For instance, the component may comprise a vehicle panel, engine component, engine block, drive train component, transmission component, brake component, wheel, tyres and so on.

It is envisaged that, in embodiments of the invention in which the component comprises a tyre, that the material comprising a plurality of boron nitride structures, the boron nitride structures comprising boron nitride nanotubes, or a hybrid of two or more forms of crystalline boron nitride structures, may comprise the boron nitride structures in a polymer matrix material, which is impregnated into the material from which the tyre is fabricated. In alternative embodiment of the invention, a plurality of boron nitride structures, the boron nitride structures comprising boron nitride nanotubes, or a hybrid of two or more forms of crystalline boron nitride structures, may be impregnated into the material from which the tyre is fabricated. In some embodiments of the invention, the boron nitride structures may be substantially homogenously distributed through the tyre. In other embodiments of the invention, at least a portion of the boron nitride structures may be concentrated in the tread of the tyre. In some embodiments of the invention, substantially all of the boron nitride structures may be concentrated in the tread of the tyre.

The boron nitride structures may be concentrated in the tread of the tyre using any suitable technique. However, in a preferred embodiment of the invention, the boron nitride structures may be added to the tread rubber portion during fabrication of a tyre.

Thus, in one aspect of the invention, the present invention reside broadly in a tyre including a tread portion, wherein the tread portion is impregnated with a plurality of boron nitride structures, the boron nitride structures comprising boron nitride nanotubes, or a hybrid of two or more forms of crystalline boron nitride structures.

The tyre may be for any suitable vehicle, including a powered vehicle or an unpowered vehicle. The tyre may be provided with an inner tube or may be a tubeless tyre.

According to a further aspect of the present invention, the invention resides broadly in a component for a watercraft at least partially fabricated from a composite material, the composite material comprising a plurality of boron nitride structures, the boron nitride structures comprising boron nitride nanotubes, or a hybrid of two or more forms of crystalline boron nitride structures, within a matrix material.

The watercraft may be of any suitable form. The watercraft may be a motorised watercraft or an unpowered watercraft. In preferred embodiments, the watercraft may comprise a boat, ship, yacht, submarine, personal watercraft (e.g., a jet ski or the like) and so on.

The component may be of any suitable type. For instance, the component may comprise an engine component, superstructure (or part thereof), hull (or part thereof), mast, foil, sail, wing, boom and so on.

The component and/or the composite material may comprise any suitable weight percent boron nitride structures in the matrix material. For instance, the component and/or the composite material may comprise between about 0.05 wt % and about 60 wt % boron nitride structures. More preferably, the component and/or the composite material may comprise between about 0.1 wt % and about 55 wt % boron nitride structures. Still more preferably, the component and/or the composite material may comprise between about 0.5 wt % and about 50 wt % boron nitride structures. Yet more preferably, the component and/or the composite material may comprise between about 0.5 wt % and about 30 wt % boron nitride structures. Even more preferably, the component and/or the composite material may comprise between about 0.5 wt % and about 20 wt % boron nitride structures. Still more preferably the component and/or the composite material may comprise between about 0.5 wt % and about 10 wt % boron nitride structures.

Any suitable matrix material may be used. For instance, the matrix material may be a polymer, a metal and/or a ceramic matrix material. In some embodiments of the invention, the matrix material may comprise a relatively light metal, such as aluminium or an alloy thereof.

It is envisaged that a component fabricated from the composite material may be relatively lightweight, durable and have relatively high impact resistance.

In another aspect, the invention resides broadly in an elongate, flexible member at least partially fabricated from a composite material, the composite material comprising a plurality of boron nitride structures, the boron nitride structures comprising boron nitride nanotubes, or a hybrid of two or more forms of crystalline boron nitride structures, within a matrix material.

The elongate, flexible member may be of any suitable size, shape or configuration. For instance, the elongate, flexible member may be substantially flat. More preferably, however, the elongate, flexible member may be provided with a substantially circular cross-sectional shape.

The elongate, flexible member may be of any suitable length. In some embodiments of the invention, the elongate, flexible member may be fabricated by extrusion, pultrusion, drawing or the like. Thus, the length of the elongate, flexible member may be determined by the nature and quantity of feed material, the diameter of the elongate, flexible material, the application in which the elongate, flexible material will be used and so on. In some embodiments of the invention, the elongate, flexible member may be cut to a desired length after fabrication.

The elongate, flexible member and/or the composite material may comprise any suitable weight percent boron nitride structures in the matrix material. For instance, the elongate, flexible member and/or the composite material may comprise between about 0.05 wt % and about 60 wt % boron nitride structures. More preferably, the elongate, flexible member and/or the composite material may comprise between about 0.1 wt % and about 55 wt % boron nitride structures. Still more preferably, the elongate, flexible member and/or the composite material may comprise between about 0.5 wt % and about 50 wt % boron nitride structures. Yet more preferably, the elongate, flexible member and/or the composite material may comprise between about 0.5 wt % and about 30 wt % boron nitride structures. Even more preferably, the elongate, flexible member and/or the composite material may comprise between about 0.5 wt % and about 20 wt % boron nitride structures. Still more preferably the elongate, flexible member and/or the composite material may comprise between about 0.5 wt % and about 10 wt % boron nitride structures.

Any suitable matrix material may be used. For instance, the matrix material may be a polymer, a metal and/or a ceramic matrix material. In a preferred embodiment of the invention, the matrix material may comprise a polymer.

The elongate, flexible member may be entirely fabricated from the composite material. Alternatively, the composite material may be coated onto the outer surface of a core fabricated from a different material. In another embodiment, the composite material may be provided in the form of a cylindrical member having a bore therethrough. Optionally, a core material may be located in the bore.

In some embodiments of the invention, the elongate, flexible member may be formed from a plurality of strands of the composite material wound or bonded together. In other embodiments of the invention, the elongate, flexible member may comprises a plurality of joined links of the composite material.

The elongate, flexible material may be used for any suitable purpose. Preferably, however, the elongate, flexible member may be used for racquet strings (such as for tennis racquets, squash racquets and the like), fishing line, and so on. In some embodiments, the elongate, flexible material may be used in the same manner as conventional chains or cables, such as transport chains or cables. Thus, the elongate, flexible material may be used to lift, tow, pull or otherwise move objects, or to restrain objects against movement.

In another aspect, the invention resides broadly in a surface coating material, the surface coating material comprising a plurality of boron nitride structures, the boron nitride structures comprising boron nitride nanotubes, or a hybrid of two or more forms of crystalline boron nitride structures, and one or more further components, the further components comprising polymers, plasticizers, pigments, binders, solvents, resins, drying oils, hardeners, curatives, diluents, adhesion promoters and driers.

In some embodiments, the surface coating material may comprise one or more additives. The additives may be of any suitable form, such as, but not limited to, thickening agents, surfactants, biocides, defoamers, UV-stabilisers and co-solvents.

The surface coating material may be of any suitable form. For instance, the surface coating material may comprise a liquid, emulsion, suspension or solid. In embodiments of the invention in which the surface coating material comprises a solid, it is envisaged that the surface coating material may comprise a powder.

Preferably, the surface coating material comprises a paint (including clear coat). In this embodiment of the invention, it is envisaged that the one or more further components comprises pigments, binders and/or solvents. It is envisaged that these components may be conventional.

In some embodiments of the invention, the surface coating material may comprise a hardenable surface coating, such as a varnish or the like. In these embodiments, the one or more further components may comprise resins, drying oils, solvents and/or driers. These components may be conventional.

In some embodiments of the invention, the surface coating material may comprise a curable surface coating, such as an epoxy resin or the like. In these embodiments, the one or more further components may comprise hardeners, diluents, adhesion promoters and/or curatives. These components may be conventional.

In some embodiments, the surface coating material may comprise a surface coating for use in marine environments, such as antifouling paint, gel coat or the like.

In some embodiments of the invention, the surface coating material may comprise a nail polish, nail enamel, nail coatings or the like. In these embodiments, the one or more further components may comprise polymers (such as, but not limited to, nitrocellulose, tosylamide-formaldehyde resin or acrylate copolymer), plasticisers (such as, but not limited to diethylphthalate, dibutylphthalate or camphor), pigments (such as, but not limited to chromium oxide greens, chromium hydroxide, ferric ferrocyanide, stannic oxide, titanium dioxide, iron oxide, carmine, ultramarine, manganese violet, mica, bismuth oxychloride, natural pearls or aluminum powder), thickeners (such as, but not limited to, stearalkonium hectorite) and/or UV-stabilisers (such as, but not limited to, benzophenone-1). These components may be conventional.

In some embodiments of the invention, the surface coating material may comprise a paint. The paint may be applied to a number of surfaces including golf balls, aerofoils, air craft, and vehicles. The paint may be applied using techniques including spray (air atomized, airless, electrostatic, high volume-low pressure) brushing, and dipping. The paint may include one or more further components. In these embodiments, the one or more further components may comprise polymers (such as, but not limited to, nitrocellulose, tosylamide-formaldehyde resin or acrylate copolymer), plasticisers (such as, but not limited to diethylphthalate, dibutylphthalate or camphor), pigments (such as, but not limited to chromium oxide greens, chromium hydroxide, ferric ferrocyanide, stannic oxide, titanium dioxide, iron oxide, carmine, ultramarine, manganese violet, mica, bismuth oxychloride, natural pearls or aluminum powder), thickeners (such as, but not limited to, stearalkonium hectorite) and/or UV-stabilisers (such as, but not limited to, benzophenone-1). These components may be conventional.

The surface coating material may comprise any suitable weight percent boron nitride structures. For instance, the surface coating material may comprise between about 0.05 wt % and about 60 wt % boron nitride structures. More preferably, the surface coating material may comprise between about 0.1 wt % and about 55 wt % boron nitride structures. Still more preferably, the surface coating material may comprise between about 0.5 wt % and about 50 wt % boron nitride structures. Yet more preferably, the surface coating material may comprise between about 0.5 wt % and about 30 wt % boron nitride structures. Even more preferably, the surface coating material may comprise between about 0.5 wt % and about 20 wt % boron nitride structures. Still more preferably the surface coating material may comprise between about 0.5 wt % and about 10 wt % boron nitride structures.

Preferably, the surface coating material comprises a settable, curable or hardenable material. In a preferred embodiment of the invention, the boron nitride structures may be substantially homogenously distributed in the surface coating material once set or hardened.

Advantageously, it is envisaged that the plurality of boron nitride structures, the boron nitride structures comprising boron nitride nanotubes, or a hybrid of two or more forms of crystalline boron nitride structures, may provide surface coating material with hydrophobic properties, thereby reducing or eliminating corrosion, water damage and the like to surfaces to which the surface coating material is applied.

In addition, the hydrophobic properties of the composite material comprising a plurality of boron nitride structures, the boron nitride structures comprising boron nitride nanotubes, or a hybrid of two or more forms of crystalline boron nitride structures, may assist in the performance of sporting equipment, both in terms of reducing or eliminating the adverse effects of water on performance (in relation to, for instance, golf balls) while also reducing slipperiness (such as when the composite material is used for the grip of sporting equipment).

Those skilled in the art would immediately understand that the performance and properties of boron nitride structures in the objects described herein is both previously unknown and previously untested. While some relatively obscure studies of the general properties of boron nitride structures may have occurred, no previous efforts to determine the suitability of boron nitride structures in the specific applications of the present invention have been made. Given the varied environments in which the objects of the present invention are used, and the different forces experienced during the use of these objects, a skilled addressee could not predict the suitability of boron nitride structures in these specific applications based on studies of the general properties of this material.

Further, there are many hundreds, if not thousands, or nanomaterials in existence. However, the applicant has surprisingly discovered that, of these many types of nanomaterials, boron nitride structures, such as boron nitride nanotubes, provide exceptional strength-to-weight ratios, while also providing excellent flexibility and elastic deformability as required. To the applicant's knowledge, the use of boron nitride structures to provide a combination of strength flexibility and elastic deformability is previously unknown, and could not have been predicted from general studies of the properties of boron nitride structures.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a method of manufacturing an item of sporting equipment according to an embodiment of the present invention.

FIG. 2 illustrates a fishing rod fabricated using a method according to an embodiment of the present invention.

FIG. 3 illustrates a golf club fabricated using a method according to an embodiment of the present invention.

FIG. 4 illustrates a portion of a golf club fabricated using a method according to an embodiment of the present invention.

FIG. 5 illustrates a golf club ball fabricated using a method according to an embodiment of the present invention.

FIG. 6 illustrates a screen for a computing device fabricated using a method according to an embodiment of the present invention.

### DETAILED DESCRIPTION

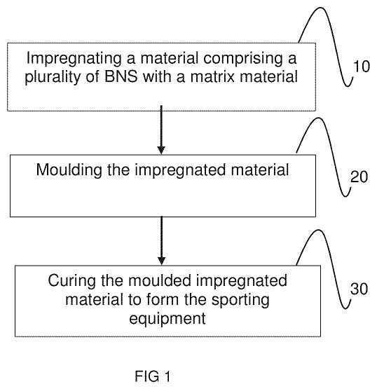

FIG. 1 illustrates a method (100) of manufacturing an item of sporting equipment according to an embodiment of the present invention.

At step 10, a material comprising a plurality of boron nitride structures, the boron nitride structures comprising boron nitride nanotubes, or a hybrid of two or more forms of crystalline boron nitride structures, is impregnated with a matrix material in the form of a polymeric matrix material. The material comprising a plurality of boron nitride structures, the boron nitride structures comprising boron nitride nanotubes, or a hybrid of two or more forms of crystalline boron nitride structures, may in the form of a tape or a sheet.

In some embodiments, the material comprising a plurality of boron nitride structures, the boron nitride structures comprising boron nitride nanotubes, or a hybrid of two or more forms of crystalline boron nitride structures, may be impregnated with a polymer. The material may be impregnated in any suitable manner. However, in the embodiment of the invention illustrated in FIG. 1, the material is impregnated by allowing liquid polymer to flow around and into the material in order to encapsulate and/or penetrate the boron nitride structures. The polymer bonds to the material such that the material and the polymer will not separate from one another. In FIG. 1, the material comprising a plurality of boron nitride nanotubes, or a hybrid of two or more forms of crystalline boron nitride structures, is simply a plurality of boron nitride structures.

In the embodiment of the invention illustrated in FIG. 1, the polymer comprises an epoxy resin, and in particular a bisphenol epoxy resin.

At step 20, the composite material may be moulded. It will be understood that the moulding of the composite material is performed in order to provide the desired shape of the item of sporting equipment. For instance, the composite material may be cast to form the item of sporting equipment or may be moulded by wrapping the composite material around a mandrel to form an elongate member.

Once the item of sporting equipment has been formed in the desired shape through the moulding process 20, the composite material may be cured 30 to form the sporting equipment. The composite material is cured through the addition of a hardener in the form of phthalic anhydride to the composite material. Curing of the composite material may also (or in addition to) be achieved by applying a source of heat to the composite material to harden the polymer and/or accelerate the curing process.

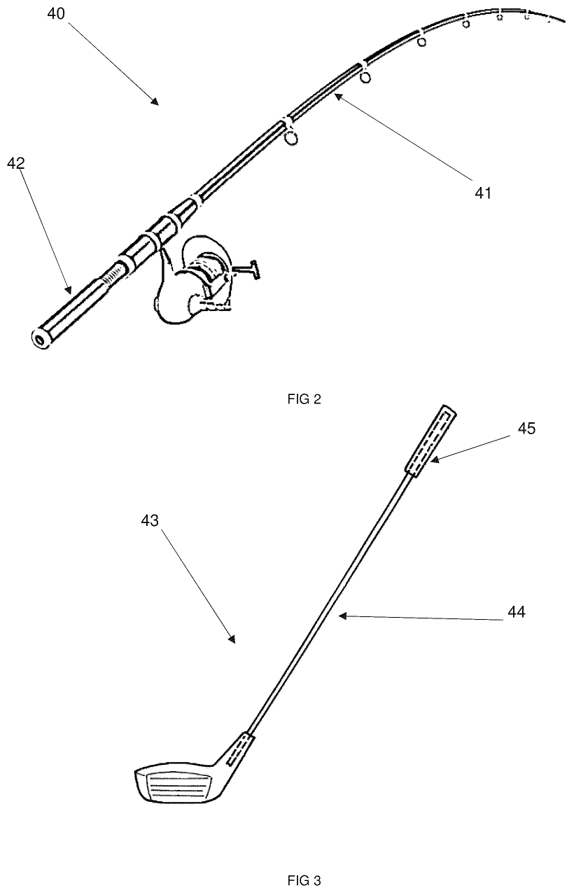

FIG. 2 illustrates a fishing rod 40 fabricated using a method according to an embodiment of the present invention. The fishing rod 40 of FIG. 2 has been fabricated using the method described in FIG. 1, and the shaft 41 of the rod 40 has been fabricated by rolling one or more sheets of composite material about a mandrel to form the elongate shaft 41 of the rod.

In addition, the grip portion, or handle 42, of the rod 40 has been fabricated in the same manner.

By fabricating the shaft 41 and the handle 42 of the fishing rod 40 according to the method of present invention, the fishing rod 40 has been provided with improved mechanical strength, improved durability and improved elastic deformability.

FIG. 3 illustrates a golf club 43 fabricated using a method according to an embodiment of the present invention. The golf club 43 of FIG. 3 has been fabricated using the method described in FIG. 1, and the shaft 44 of the golf club 43 has been fabricated by rolling one or more sheets of composite material about a mandrel to form the elongate shaft 44 of the rod.

In addition, the grip portion, or handle 45, of the golf club 43 has been fabricated in the same manner.

By fabricating the shaft 44 and the handle 45 of the golf club 43 according to the method of present invention, the golf club 43 has been provided with improved mechanical strength, improved durability and improved elastic deformability.

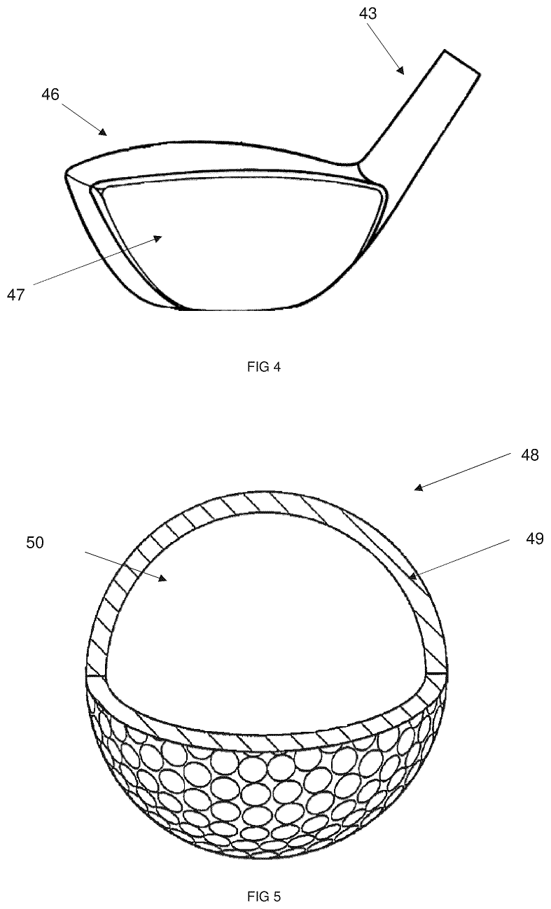

FIG. 4 illustrates a portion of a golf club 43 fabricated using a method according to an embodiment of the invention. Specifically, FIG. 4 illustrates the head 46 of the golf club 43.

The head 46 of the golf club 43 includes a club face 47 fabricated from a composite material, and according to the method, of the present invention. The club face 47 is fabricated in much the same way as described in relation to FIG. 1, with the exception that the club face 47 is shaped from the composite material by bladder moulding, casting or the like.

FIG. 5 Illustrates a golf ball 48 fabricated using a method according to an embodiment of the invention. Specifically, FIG. 5 illustrates a golf ball 48 having a cover 49 fabricated according to an embodiment of the invention. The cover 49 encapsulates the golf ball core 50. The cover 49 may also be provided with a surface coating fabricated according to an embodiment of the invention.

By fabricating the golf ball 48 with a cover 49 comprising a plurality of boron nitride structures, the boron nitride structures comprising boron nitride nanotubes, or a hybrid of two or more forms of crystalline boron nitride structures, the golf ball 48 will be more hydrophobic and durable such that the golf ball 48 will not scratch as readily as conventional golf balls. Furthermore, the cover 49 is elastically deformable even though it is comprises a plurality of boron nitride structures, meaning that the performance of the golf ball 48 will not be adversely affected.

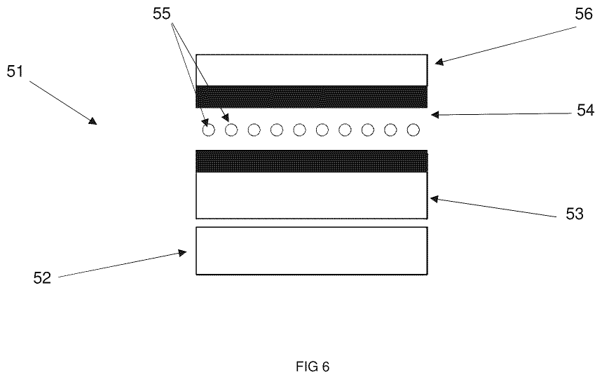

FIG. 6 illustrates a screen 51 for a computing device fabricated using a method according to an embodiment of the present invention. In particular, the screen 51 comprises a touchscreen for use with a computing device, such as a mobile telephone, laptop computer, smart watch, computing tablet or the like.

The screen 51 comprises a plurality of layers configured to be located over the LCD display 52 of the computing device. A transparent inner layer 53 of the screen 51 comprises a glass layer that is configured for adhesion to the LCD display 52. The transparent inner layer 53 is located between the LCD display and a spacer layer 54 of the screen 51. The spacer layer 54 comprises a plurality of sensors 55 configured to sense touching of the screen 51 (whether by a user's finger, or an object such as a stylus) and react accordingly.

The screen further comprises an outer coated layer 56. Preferably, the outer coated layer 56 is a polyester-coated layer, and is configured to be the layer a user contacts with their finer or an object (such as a stylus) to operate the touchscreen 51. The outer coated layer 56 may be fabricated from a substantially transparent material, such as glass or a polymer (and particularly a polycarbonate). In the embodiment of the invention illustrated in FIG. 6, the outer coated layer 56 is at least partially fabricated from a material comprising a plurality of boron nitride structures. The boron nitride structures may be embedded or impregnated within the material from which the outer coated layer 56 is formed.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method of manufacturing an item of sporting equipment comprising:
impregnating a material comprising a plurality of boron nitride structures, the boron nitride structures comprising boron nitride nanotubes, or a hybrid of two or more forms of crystalline boron nitride structures, with a polymer to form a composite material;
moulding the composite material; and
curing the composite material,
wherein the item of sporting equipment is at least partially fabricated from the composite material.

2. The method according to claim 1, wherein the composite material comprises between 0.5 wt % and 50 wt % of the boron nitride structures.

3. The method according to claim 1, wherein the composite material further comprises a plurality of carbon nanotubes.

4. The method according to claim 3, wherein the composite material comprises between 0.5 wt % and 50 wt % of the carbon nanotubes.

5. The method according to claim 1, wherein the polymer comprises an epoxy resin.

6. The method according to claim 1, wherein the item of sporting equipment is formed from a laminated composite material comprising a plurality of layers of the composite material that are laminated together.

7. The method according to claim 1, wherein the composite material is cured by at least one of using a hardener, applying pressure, or applying temperature to the composite material to form the item of sporting equipment.

8. The method according to claim 1, wherein the composite material is moulded using bladder moulding.

9. The method according to claim 1, wherein the composite material further comprises a metal.

10. The method according to claim 9, wherein the metal is provided in the form of a metal-boron nitride nanotube layered structure wherein the metal is at least partially coated with the boron nitride structures, a plurality of metal particles dispersed within the composite material or a plurality of the boron nitride structures dispersed within a metal-based structure.

11. The method according to claim 9, wherein the metal comprises titanium, a titanium alloy, aluminium or an aluminium alloy.

12. (canceled)

13. An item of sporting equipment or a portion thereof manufactured according to the method of claim 1.

14. The item of sporting equipment or portion thereof according to claim 13, wherein the item of sporting equipment comprises a golf club, a golf ball or a fishing rod.

15. The item of sporting equipment or portion thereof according to claim 14, wherein the item of sporting equipment comprises a shaft of the golf club or a shaft of the fishing rod.

16. The item of sporting equipment or portion thereof according to claim 13, wherein the portion thereof comprises a club face of a golf club.

17. (canceled)

18. A screen for a computing device, the screen comprising at least one layer, wherein the at least one layer comprises a material comprising a plurality of boron nitride structures, the boron nitride structures comprising boron nitride nanotubes, or a hybrid of two or more forms of crystalline boron nitride structures.

19. The screen for a computing device according to claim 18, wherein the screen comprises three layers, the three layers comprising a transparent layer, a spacer layer and an outer coated layer, and wherein the outer coated layer comprises the material comprising the plurality of boron nitride structures.

20. (canceled)

21. The screen for a computing device according to claim 18 wherein the screen comprises a touchscreen.

22. The screen for a computing device according to claim 18, wherein the computing device comprises a mobile telephone, computing tablet, laptop computer or smart watch.

23. A component for a watch, the component comprising a material comprising a plurality of boron nitride structures, the boron nitride structures comprising boron nitride nanotubes, or a hybrid of two or more forms of crystalline boron nitride structures.

24.-28. (canceled)
